(19) United States
(12) Patent Application Publication
(10) Pub. No.: US 2009/0324869 A1
(43) Pub. Date: Dec. 31, 2009

(54) Substrate for Storage Media, and Method for Manufacturing a Recycled Resin Substrate

(75) Inventors: Tetsuya Imai, Saitama (JP); Yasuo Hosoda, Saitama (JP); Noriyoshi Shida, Saitama (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Tokyo (JP)

(21) Appl. No.: 11/884,457

(22) PCT Filed: Feb. 21, 2006
(86) PCT No.: PCT/JP2006/303035

§ 371 Date: Apr. 11, 2008

(30) Foreign Application Priority Data
Feb. 22, 2005 (JP) 2005-045049

(51) Int. Cl. B32B 3/02; B32B 38/10

(52) U.S. Cl. 428/64.4; 156/344

(57) ABSTRACT

The main object of the present invention is to provide a substrate for storage media capable of recording and reproducing data for a limited period and capable of being easily recycled, and a method for manufacturing a recycled resin substrate reusable as such a substrate for storage media. In order to achieve the aforementioned object, the present invention provides a substrate for storage media comprising: a resin substrate containing a starch resin; and a resin layer formed on the resin substrate.

### TECHNICAL FIELD

The present invention relates to a recyclable substrate for storage media, used for storage media such as an optical disk, which can reproduce data for a limited period. The present invention also relates to a method for manufacturing a recycled resin substrate.

### BACKGROUND ART

Conventionally, as information storage media for recording and reproducing data such as video data, sound data and computer data, an optical disk such as a DVD, a card type one has been used. Recently, in such information storage media, those capable of reproducing data or the like only for a limited period have been proposed. Such information storage media is used, for example, for a rental DVD or the like. In this case, since reproduction is disabled after elapse of a certain period, the user needs not to return the information storage media to the store after the rental period.

As storage media enabling reproduction or recording for a limited period, for example, Patent Document 1 proposes a method of providing a reactive layer, which reacts with the oxygen in the atmosphere, in storage media. In this case, since the reactive layer reacts with the oxygen in the atmosphere or the like, so as to be opaque, the reflectance of the laser beam to be directed to the storage media for the data reproduction or the like is lowered, so as to disable the data reproduction or the like. Moreover, Patent Document 2 proposes a method in which a capsule for discharging a chemical is retained in the storage media. In this case, the chemical discharged from the capsule and a metal reflection layer or the like react with each other so as to disable the data reproduction or the like. However, according to any of these methods, a reactive layer or a storage area for storing the capsule or the like should be provided additionally so that improvement in terms of the manufacturing efficiency and the cost is desired.

Moreover, including such storage media which enables reproduction and recording for a limited period, in storage media generally used, there is a problem that the majority thereof is abandoned after the use without recycling. The storage media generally has a multiple layer structure having a plurality of material layers such as a substrate made of a polycarbonate resin, and a recording layer to be used for recording and reproducing an information signal. Therefore, when the storage media is pulverized with the above-mentioned layers present as a mixture, and the pulverized product is used as a molding material, since a large amount of impurities such as a metal are introduced into the resin material after recycling, the bending strength, the bending elastic modulus or the like of the molded products, which are reshaped by using the same as the material, are unstable so that the application thereof is limited in many aspects.

Moreover, a method of using the molding material, of which the metal layer or the like is removed by a mechanical polishing method or a chemical process method, has been proposed (for example, Patent Document 3 or the like). According to these methods, expensive facility is needed, and furthermore, there are many problems in terms of the process efficiency. Moreover, in the case of carrying out the chemical process, use of a large quantity of chemicals is needed so that there is the risk of affecting the environment.

Moreover, according to any of these methods, since special device, facility or the like is needed, there is a problem that the users themselves cannot separate the recyclable ones from other waste.
Patent Document 1: Tokuhyou (Japanese translation of PCT international application) No. 2004-528667
Patent Document 2: Tokuhyou (Japanese translation of PCT international application) No. 2003-528414
Patent Document 3: Japanese Patent Application Laid-Open No. 2001-43572

### DISCLOSURE OF THE INVENTION

### Problems to be Solved by the Invention

Accordingly, provision of a substrate for storage media capable of recording and reproducing data for a limited period and capable of being easily recycled, and a method for manufacturing a recycled resin substrate reusable as such a substrate for storage media is desired.

### Means for Solving the Problems

The present invention provides a substrate for storage media comprising: a resin substrate containing a starch resin; and a resin layer formed on the resin substrate.

Moreover, the present invention provides a substrate for optical disk comprising: a resin substrate containing a starch resin; and a resin layer, formed on the resin substrate, having a recording pit or a recording guide groove on the surface.

Furthermore, the present invention provides a method for manufacturing a recycled resin substrate, the method comprising a peeling step, in which the recycled resin substrate is formed, by peeling off a recording layer and a resin layer of storage media comprising a resin substrate containing a starch resin, the resin layer formed on the resin substrate, and the recording layer formed on the resin layer.

### BRIEF DESCRIPTION OF THE DRAWINGS

FIG. 1 is a schematic cross-sectional view showing an example of a substrate for storage media of the present invention;

FIG. 2 is a schematic cross-sectional view showing an example of a substrate for optical disk of the present invention; and

FIG. 3 is a process diagram showing an example of a method for manufacturing a substrate for storage media of the present invention.

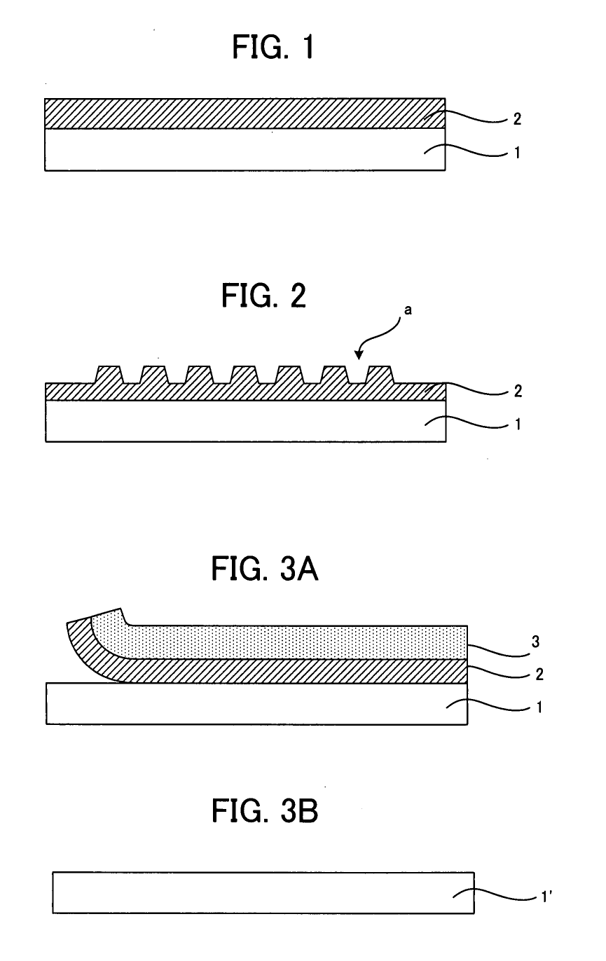

### EXPLANATION OF REFERENCES

1 Resin substrate
2 Resin layer
3 Recording layer

### BEST MODE FOR CARRYING OUT THE INVENTION

The present invention relates to a recyclable substrate for storage media used for storage media such as an optical disk, which can reproduce data with the period limitation, and a method for manufacturing a recycled resin substrate. Hereafter, each will be explained.

### A. Substrate for Storage Media

First, the substrate for storage media of the present invention will be explained. The substrate for storage media of the present invention comprises: a resin substrate containing a starch resin; and a resin layer formed on the resin substrate.

In the present invention, since a resin substrate containing a starch resin is used, a precipitating material which is easily precipitated on the surface is contained in the resin substrate. Thereby, in storage media using the substrate for storage media of the present invention, after elapse of a certain period from the manufacturing, the precipitating material is bloomed or bled at the interface between the resin substrate and the resin layer so that concave-convex portions can be formed on the resin layer surface, and furthermore, on the surface of the recording layer formed on the resin layer or the like. Therefore, by using the substrate for storage media of the present invention, storage media, that data recording, reproduction or the like is disabled after elapse of a certain period form the manufacturing, can be provided without the need for providing a special layer, a region for storing chemicals or the like.

Moreover, since the concave-convex portions generated on the storage media can be confirmed by the observation of the storage media surface, whether or not the storage media is usable can be judged by the observation of the user, without the need for playing the same in a player, and thus it is advantageous.

Moreover, in the present invention, since a resin substrate containing a starch resin is used, the ratios of expansion and shrinkage by moisture absorption, drying or the like of the resin substrate and the resin layer can be different. Therefore, due to the expansion-shrinkage ratio difference, and due to the precipitated substance generated at the interface between the resin substrate and resin layer, one that can be easily peeled off at the interface of the resin substrate and the resin layer can be provided. Thereby, in the storage media manufactured by using the substrate for storage media of the present invention, the resin layer, the recording layer or the like, formed on the resin layer can be peeled off from the resin substrate, after use, so that the resin substrate can be recycled. Moreover, since the peeling operation can be carried out at a general household, the user him/herself can separate the recording layer or the like from the resin substrate for recycling the resin substrate, and thus it is advantageous.

Hereafter, the substrate for storage media in the present invention will be explained in detail for each configuration.

### 1. Resin Substrate

First, the resin substrate used in the present invention will be explained. The resin substrate used in the present invention is not particularly limited as long as it contains a starch resin and the resin layer can be formed thereon. For example, it may be a substrate made of only a starch resin, or it may be made of a combination of a starch resin and another resin or the like.

In the present invention, the starch resin may be contained in such an amount that its effect can be exhibited in the resin substrate. Specifically, it is contained preferably in an amount of 10% by weight or more, and particularly preferably in an amount of 30% by weight or more. Thereby, non-polymer components: such as monomers or dimers, and oil components which are contained in the starch resin or generated by dissociation; oil components which are different from main resin components contained in the organisms used as the raw materials, such as corn oil derived from corn raw materials or precipitating materials of fatty acid generated when corn oil is denatured, decomposed and bound, can easily bloom or breed toward the resin substrate surface. As the starch resin, those generally used as a starch resin can be used. For example, those using corn, rice, potato or the like as the raw material can be used.

Moreover, in the present invention, in combination with the starch resin, for example, resins such as polycarbonate, polypropylene, polyethylene, polylactic acid, and an amorphous resin can be used. In the present invention, it is particularly preferable to use polycarbonate, polypropylene or an amorphous resin. Moreover, in the present invention, it is preferable that a resin other than the starch resin is contained by 9 or less, in particular, by 2 or less based on the content (weight) of the starch resin as 1. Depending on the amount of the resin other than the starch with respect to the amount of the starch resin, the amount of the precipitating material to be precipitated on the resin substrate surface, the expansion-shrinkage ratio by moisture absorption or drying of the resin substrate or the like can be varied. Therefore, by adjusting the amount of the resin other than the starch resin, the usable period of storage media manufactured by using the substrate for storage media of the present invention can be adjusted.

In the present invention, it is preferable that, after being left for a predetermined time, a compound having a carbonyl group is precipitated on the surface of the resin substrate. Thereby, since the compound containing the carbonyl group is precipitated at the interface between the resin substrate and the resin layer after elapse of a certain period after the manufacturing, the interface is in a state to be easily peeled off by effectively lowering the adhesion force between the resin substrate and the resin layer. Furthermore, since the influence of the precipitated compound is exerted on the surface, concave-convex portions is formed on the resin layer surface, and furthermore, on the surface of the recording layer formed on the resin layer or the like so that storage media disabling recording and reproduction of the data or the like can be provided.

Moreover, although the compound having a carbonyl group is not particularly limited, for example, an aliphatic ester compound can be presented. Presence of the compound having a carbonyl group can be confirmed by the analysis of the FTIR (Fourier transform infrared spectrophotometer).

Moreover, in the present invention, it is preferable that the resin substrate contains: glycerin in an amount of 2% by mass or more; methyl lactate in an amount of 0.02% by mass or less; and methoxyethyl acetate in an amount of 0.08% by mass or less. That is because the methyl lactate and the methoxyethyl acetate contained in the resin substrate have the effect of preventing peel-off of the resin layer from the resin substrate. Thereby, after elapse of a certain period, the resin layer can easily be peeled off from the resin substrate. On the other hand, the upper limit of the glycerin content in the resin substrate is 10% by mass or less. If the glycerin content is too high, the trouble arises that the resin layer is peeled off from the resin substrate at the time of manufacturing of the storage media or the like. Also, the risk that the use thereof is disabled before elapse of the certain period, because of the deformation of the substrate for storage media due to the moisture absorption property of the glycerin, arises.

Moreover, in the present invention, at the time of manufacturing the resin substrate, specifically, at the time of manufacturing the starch resin, it is preferable that glycerin is added in an amount of 11% by mass or more. Thereby, a resin substrate having the resin layer to be easily peeled off after elapse of a certain period can be provided. On the other hand, the upper limit of the glycerin addition amount at the time of manufacturing the starch resin is generally 16% by mass or less.

In addition to the starch resin and the other resins, as needed, additives or the like may be contained in the resin substrate. Moreover, by adjusting the amount of the additives or the like, the amount or the like of the precipitating material to be precipitated on the resin substrate surface may be adjusted, or the period may be adjusted.

### 2. Resin Layer

Next, the resin layer used in the present invention will be explained. Any resin layer may be used in the present invention without limitation insofar as it is formed on the resin substrate. The type, thickness, function and the like of the resin layer are properly selected in accordance with the use of the substrate for storage media.

When the substrate for storage media is used for an optical disk, the resin layer is usually designed to be a layer provided with a recording pit or recording guide groove. When the substrate for storage media is used as card type storage media, the resin layer may be formed as a coating layer, paint layer or the like.

As the material of the resin layer, materials used in resin layers used for general substrates for storage media may be used. The materials of the resin layer may contain, for example, ultraviolet-curable resins, thermoset resins, thermoset and ultraviolet-curable resins or solvent-volatilized curable resins. Specific examples of these resins include urethaneacrylate resins, epoxyacrylate resins, polyester resins, epoxy resins, acryl resins, urethane resins and melamine resins or mixtures of these resins. Further, resins obtained by adding pigments and additives to the above-mentioned resins may be used.

Also, there is no particular limitation to a method for forming such a resin layer. Examples of the method include: a method of forming a resin layer by a general coating method on the resin substrate; a method of forming a resin layer by adhering a sheet-like layer to the resin substrate; and a method in which a resin layer having a specified shape is formed by embossing with a stamper or the like when the aforementioned resin is cured.

The thickness of the resin layer as mentioned above is usually about 1 μm to 600 μm and preferably about 10 μm to 100 μm, though it may be selected in accordance with the type of the substrate for storage media. In the case where it is thicker than the above-mentioned thickness, the concave-convex portions generated on the resin layer surface is made smaller even though the precipitating material is bloomed or bled between the resin substrate and the resin layer. Therefore, it is difficult to make storage media, using the substrate for storage media in the present invention, to be the one usable for a limited period.

### 3. Substrate for Storage Media

The substrate for storage media of the present invention is not particularly limited as long as it has the resin substrate and resin layer. According to need, a necessary layer may be formed appropriately. Moreover, the application of the substrate for storage media of the present invention is not particularly limited. For example, it may be used for an optical disk such as DVD and CD, and moreover, it may be used for a card type storage media.

In the present invention, especially after elapse of a predetermined period after manufacturing, it is preferable to have surface roughness of 5 nm or more, in particular, in a range of 6.5 nm to 150 nm is particularly preferable. Thereby, at the time of using the substrate for storage media of the present invention for storage media, ones having concave-convex portions on the recording layer or the like can be provided so that storage media capable of reproduction or the like for a limited period can be provided. The surface roughness can be measured with a contact type surface roughness measuring machine or shape measuring machine such as DEKTAK, a non-contact type surface roughness measuring machine or shape measuring machine such as AFM. In the case of using a contact type surface roughness measuring machine or shape measuring machine, in order not to flaw the surface of the substrate for storage media, it is preferable that the load on the surface of the substrate for storage media is 1 mg or less.

### 4. Others

On the other hand, in a substrate for storage media using a resin substrate containing a starch resin, when the substrate for storage media is used in a product such as an optical disk, there is a problem of the storage stability, in some cases, such as peel-off of the resin layer from the resin substrate at the time of manufacturing or before the use of the product.

Accordingly, provision of a substrate for storage media, whose adhesion strength of the resin substrate and the resin layer is certainly ensured during the storage, at the time of the manufacturing or the like, has been desired.

For solving the problems, in the present invention, it is preferable that a resin substrate containing a starch resin, and a resin layer formed on the resin substrate are provided, wherein the glycerin content of the resin substrate is 2% by mass or less, and methyl lactate is contained in an amount of more than 0.02% by mass, and methoxyethyl acetate in an amount of more than 0.08% by mass. Thereby, although the recycling property of the substrate for storage media is lowered slightly, the storage stability of the substrate for storage media can sufficiently be ensured.

Except for the contained glycerin amount, methyl lactate amount and methoxyethyl acetate amount, the resin substrate may be same as that explained in the item for the resin substrate. Moreover, as to the other configurations such as the resin layer, they may be same as those explained in the items for the resin layer and substrate for storage media.

### B. Substrate for Optical Disk

Next, the substrate for optical disk of the present invention will be explained. The substrate for optical disk of the present invention is characterized in having: resin substrate containing a starch resin; and a resin layer formed on the resin substrate, and having a recording pit or a recording guide groove on the surface. The recording pit or the recording guide groove composed of concave-convex portions may be formed on the surface of the resin layer in the substrate for storage media mentioned above. As such a substrate for optical disk, for example as shown in FIG. 2, one comprising a resin substrate 1, and a resin layer 2 formed on the resin substrate 1, and having a guide groove “a” may be used.

In the present invention, since a resin substrate containing a starch resin is used, concave-convex portions may be formed on the surface of the substrate for optical disk after elapse of a certain period from the manufacturing. Therefore, in an optical disk using the substrate for optical disk of the present invention, data recording, reproduction or the like can be disabled after elapse of a certain period form the manufacturing, without the need for providing a special layer, a region for storing chemicals or the like.

Moreover, since the concave-convex portions generated on the optical disk can be confirmed by the observation of the optical disk surface, whether or not the storage media is usable can be judged by the observation of the user, without the need for playing the same in a player, and thus it is advantageous.

Moreover, in the present invention, since a resin substrate containing a starch resin is used, one that can be easily peeled off at the interface of the resin substrate and the resin layer can be provided. Thereby, in the optical disk manufactured by using the substrate for optical disk of the present invention, the resin layer, the recording layer or the like, formed on the resin layer can be peeled off from the resin substrate, after use, so that the resin substrate can be recycled. Moreover, since the peeling operation can be carried out at a general household, the user him/herself can separate the recording layer or the like, formed on the resin layer, from the resin substrate for recycling the resin substrate, and thus it is advantageous.

Since the resin substrate to be used for a substrate for optical disk of the present invention is same as that explained in the item of “A. Substrate for storage media” mentioned above, detailed explanation is omitted here.

### (Resin Layer)

The resin layer used in the present invention is formed on the resin substrate and is provided with a recording pit or recording guide groove. This resin layer may be formed, for example, by applying a resin layer forming coating solution containing an ultraviolet-curable resin or a thermoset and ultraviolet-curable resin on the resin substrate, and then, curing using heat or ultraviolet light in the condition that the coating layer is embossed by a stamper or the like. Alternatively, for example, an adhesive sheet for forming a resin layer, which contains an ultraviolet-curable resin or a thermoset and ultraviolet-curable resin, may be applied on the resin substrate and embossed by a stamper or the like to form the resin layer. As the stamper, one which is generally used in the formation of optical disks may be used. Further, examples of the material used to form the resin layer include acryl resins and urethaneacrylate resins.

Moreover, although the thickness of the resin layer having the guide groove may be selected appropriately according to the kind of the substrate for storage media, the average thickness is generally about 1 μm to 600 μm, it is particularly preferably about 10 μm to 100 μm.

### (Substrate for Optical Disk)

The substrate for optical disk of the present invention is not particularly limited as long as it includes the resin substrate, and resin layer having a recording pit or a recording guide groove. According to need, it may appropriately have other layers.

In the present invention, especially after elapse of a predetermined period after manufacturing, it is preferable that the surface roughness is λ/(40n) or more, and more preferably λ/(35n) or more. Here, λ is the laser wavelength to be used for recording or reproduction of the optical disk, and “n” is the refractive index of the material used for the surface side of recording or reading a signal in the optical disk. Moreover, the surface roughness is specifically, 5 nm or more, and it is particularly preferably in a range of 6.5 nm to 150 nm. Thereby, at the time of using the substrate for optical disk of the present invention for an optical disk, concave-convex portions can be generated on the recording layer or the like so that an optical disk capable of reproduction or the like for a limited period can be provided.

Moreover, in the present invention, it is preferable that the concave-convex portions are generated for Tp (track pitch)/2 cycles or more. Thereby, tracking cannot be closed in the optical disk using a substrate for optical disk of the present invention.

### C. Method for Manufacturing a Recycled Resin Substrate

Next, a method for manufacturing a recycled resin substrate of the present invention will be explained. The method for manufacturing a recycled resin substrate is a method comprising a peeling step, in which the recycled resin substrate is formed, by peeling off a recording layer and a resin layer of storage media comprising a resin substrate containing a starch resin, the resin layer formed on the resin substrate, and the recording layer formed on the resin layer.

For example, as shown in FIG. 3, the method for manufacturing a recycled resin substrate of the present invention is a method comprising a peeling step, in which: a recording layer 3 and a resin layer 2, of storage media comprising a resin substrate 1, the resin layer 2 formed on the resin substrate 1, and the recording layer 3 formed on the resin layer 2, are peeled off (FIG. 3A); and the recycled resin substrate 1′, that can be used again for manufacturing storage media, is formed (FIG. 3B).

In the present invention, since the resin substrate containing a starch resin is used, a precipitating material, which is easily precipitated on the surface, can be contained in the resin substrate. Moreover, the ratios of expansion and shrinkage by moisture absorption, drying or the like of the resin substrate and the resin layer can be different. Therefore, due to the expansion-shrinkage ratio difference between the resin substrate and the resin layer, and due to the precipitated substance generated at the interface between the resin substrate and resin layer, one that can be easily peeled off at the interface of the resin substrate and the resin layer can be provided. Thus, the recycled resin substrate can be easily formed without the need of special equipments, chemicals or the like.

The recycled resin substrate manufactured in the present invention is used again for storage media by forming a resin layer, a recording layer or the like on the recycled resin substrate.

Hereinafter, the peeling step in the method for manufacturing a recycled resin substrate of the present invention will be explained.

### (Peeling Step)

The peeling step in the present invention is a step of peeling off the recording layer and resin layer from the surface of the resin substrate. The method of peeling off the recording layer and resin layer is not particularly limited. Such a peeling method may be, for example, a method of attaching an adhesive member on the recording layer and pulling in a predetermined direction to separate the interface of the resin layer and resin substrate or the like. Moreover, for example, it may be a method of grasping a part of the recording layer and resin layer and pulling in a predetermined direction to separate the interface of the resin layer and resin substrate or the like.

A member for facilitating the peeling operation or the like may be provided in the storage media. As such a member, for example, a peeling layer formed in a part of the resin substrate, a notch part formed in the resin layer or the like can be presented.

Here, the storage media used in the method for manufacturing a recycled resin substrate of the present invention is not particularly limited. For example, it may be an optical disk such as DVD and CD, or it may be a card type storage media or the like. Moreover, the recording layer in the present invention is not particularly limited as long as it is a layer capable of recording or reproducing the data. For example, it may have laminated layers used in common storage media such as a reflection film layer, a recording layer and a dielectric protection layer. Furthermore, it may be one having a cover or the like laminated thereon. Moreover, since the resin layer and the resin substrate in the storage media used in the present invention may be same as those mentioned above, detailed explanation is omitted here.

### (Others)

In the method for manufacturing a recycled resin substrate of the present invention, in addition to the peeling step, for example, a step of washing a formed recycled resin substrate, a step of polishing the surface or the like may be provided appropriately as needed.

The present invention is not limited to the above-mentioned embodiments. The embodiments are merely examples, and any one having the substantially same configuration as the technological idea disclosed in the claims of the present invention and the same effects is included in the technological scope of the present invention.

### EXAMPLES

### Example 1

Using a starch resin (Corn starch resin WO-100 provided from Nissho Musen Co., Ltd.), a 12 cm diameter disk-like flat resin substrate was produced by the injection molding method. On this resin substrate, a ultraviolet-curable resin (manufactured by Mitsubishi Rayon Co., Ltd., acryl based ultraviolet-curable resin) was coated and was cured under the condition that it was embossed by a clear stamper to form a resin layer having a spiral groove (guide groove) with a 0.320 μm pitch, to make a substrate for optical disk of the present invention.

### (Evaluation)

A reflecting layer (Al—Pd—Sn—O), a dielectric protective layer (Nb—Si—O—N), a recording layer (Bi—Ge—N) and a dielectric protective layer (Nb—Si—O—N) were deposited on the above-mentioned substrate for optical disk in this order by a sputtering method. The thickness of these layers were 50 nm, 30 nm, 15 nm and 24 nm respectively. Thereafter, a polycarbonate sheet of 0.1 mm in thickness was applied as an incident side substrate (cover layer) on the dielectric protective layer by using an ultraviolet-curable resin as an adhesive.

Thereafter, with the produced optical disk left in the room environment, change in the focus signal, the tracking signal and the signal surface roughness over time was examined. The signal evaluation was carried out with an optical head having a 405 nm wavelength and a 0.85 numerical aperture objective lens by a 4.92 mm/s linear speed. Moreover, the roughness of the substrate with the signal surface was measured with DEKTAC with a 1 mg load.

As a result, the surface roughness immediately after the production of the optical disk was equivalent to the glass substrate surface. Moreover, the surface roughness one day after the production of the optical disk was less than λ/(40n). (λ: the laser wavelength to be used for recording or reproduction, “n”: the refractive index of the material used for the recording surface side or the reading surface side of a signal.)

Moreover, two days after the production of the optical disk, the surface roughness was confirmed to be λ/(40n) or more so that tracking cannot be closed. Moreover, generation of the irregularity at the time tracking cannot be closed was Tp/2 cycles or more (Tp: track pitch).

### Example 2

A ultraviolet-curable resin (manufactured by DAINIPPON INK AND CHEMICALS, Inc., acryl based ultraviolet-curable resin SD-693) was applied on substrate made of a starch resin (trade name: Corn Starch Resin WO-100, provided from NISSHO MUSEN Co., Ltd.) by a thickness of 100 μm to form a substrate for storage media of the present invention.

### (Evaluation)

Cross-cut test was carried out, based on the JIS K5400-1990, for the ultraviolet-curable resin layer surface of the substrate for storage media. Using a cellophane tape (“CT18” produced by Nichiban Co., Ltd.), after adhering the tape by using the ball of a finger and an eraser, it was peeled off perpendicularly to the surface. Judgment was represented by the number of the squares that was not peeled off, out of 100 squares. In the case where the ultraviolet-curable resin layer is not peeled off, it is represented as 100/100, and in the case where it is completely peeled off, it is 0/100.

As a result, after 10 minutes, it was 55/100, after 1 hour, 2/100, after 6 hours, 0/100, and after 70 hours, 0/100.

From the results, it was confirmed that the adhesion strength of the ultraviolet-curable resin layer and the resin substrate is reduced after the production so that it was confirmed that the resin layer can easily be peeled off after the use.

### Example 3

In the same manner as in the example 2, a substrate for storage media was produced and the cross-cut test was carried out to confirm that the ultraviolet-curable resin can be peeled off. Subsequently, using the resin substrate, whose ultraviolet-curable resin layer was peeled off in the cross-cut test, again as a resin substrate (recycled resin substrate), a substrate for storage media was produced in the same manner as in the example 2.

### (Evaluation)

After one hour from the production of the substrate for storage media, the cross-cut test same as the example 2 was carried out on the ultraviolet-curable resin layer surface of the substrate for storage media, and the result was 0/100. From the results, it was confirmed that the peeling ability of the ultraviolet-curable resin and the resin substrate can be maintained even in the case of using a recycled resin substrate.

### Example 4

Using a starch resin (Corn starch resin WO-100 provided from Nissho Musen Co., Ltd.), a flat resin substrate was produced by the injection molding method.

### (Evaluation)

After elapse of 24 hours from the production of the resin substrate, generation of white stripe substance (precipitating material) was confirmed on the resin substrate surface.

The IR spectrum was measured with the FTIR (Fourier transform infrared spectrophotometer) for the white stripe substance and the white stripe non-generated portion (normal portion) of the resin substrate surface. Moreover, as to the starch resin (pellets), the IR spectrum was measured in the same conditions. The measurement conditions are shown below.

### Measurement Conditions

FTIR device: Nexus 470 (produced by ThermoNicolet Limited)
Attachment: 1 time reflection ATR “Thunder Dorm” (produced by SPECTRA-TECH, INC.)

### Detector: DTGS

Measurement mode: Reflection
Resolution: 8 cm⁻¹
Integration times: 32 times
Observation wave numerical range: 4,000 to 650 cm⁻¹
Data processing software: Omnic ver 5.1

As a result of the comparison of the IR spectra of the white stripe substance, the white stripe non-generated portion (normal portion) and the starch resin, as a difference, only in the white stripe substance, the C═O absorption of a carbonyl group presumed to be an aliphatic ester compound or the like was observed. From this, it is considered that an aliphatic ester compound is contained in the white stripe substance.

### Example 5

A starch resin was produced with the amount of the glycerin to be added at the time of producing the starch resin of 16% by mass. Using the starch resin, a flat resin substrate was produced by the injection molding method. By applying an ultraviolet-curable resin (Acrylic ultraviolet-curable resin SD-693 produced by Dainippon Ink and Chemicals, Incorporated) by about 100 μm thickness on the resin substrate and curing, a substrate for storage media was provided.

### Example 6

In the same manner as in the example 5, except that the amount of the glycerin to be added at the time of producing a starch resin was changed to 11% by mass, a substrate for storage media was produced.

### Example 7

In the same manner as in the example 5, except that the amount of the glycerin to be added at the time of producing a starch resin was changed to 8% by mass, a substrate for storage media was produced.

### (Evaluation)

By the same method as in the example 2, the cross-cut test was carried out on the substrates for storage media produced in the examples 5 to 7. The results are shown in the table 1.

TABLE 1

| | Amount of added glycerin | Elapsed time | | | | | | |
|---|---|---|---|---|---|---|---|---|
| | (% by mass) | 10 min | 1 h | 6 h | 24 h | 48 h | 240 h | 360 h |
| Example 5 | 16 | 33/100 | 8/100 | 1/100 | 0/100 | 0/100 | 0/100 | 0/100 |
| Example 6 | 11 | 100/100 | 100/100 | 97/100 | 86/100 | 84/100 | 61/100 | 56/100 |
| Example 7 | 8 | 100/100 | 100/100 | 100/100 | 100/100 | 100/100 | 100/100 | 100/100 |

From the results of the table 1, it was confirmed that the adhesion strength of the ultraviolet-curable resin layer and the resin substrate is varied depending on the amount of the glycerin to be added at the time of producing the starch resin.

Here, taking the days needed for shipping, distribution and viewing into consideration, it is desirable that the adhesion force would be such an extent so as to be easily peeled off by scratching with a finger nail or the like, by about 10 to 15 days thereafter. As to the cross-cut test, 2 points or less by the JIS evaluation points, that is, the adhesion force to have 35 to 65% or more peeled off is considered to be desirable. Therefore, to obtain an optical disk which has the adhesion strength to be peeled off easily with hands after the use, in the stage of the practical use, while ensuring sufficient adhesion strength in the production process of the optical disk, it is preferable to produce a resin substrate using a starch resin containing added glycerin amount of 11% by mass or more (Examples 5 and 6).

### (Qualitative-Quantitative Analyses)

The GC (gas chromatography), GC/MS (gas chromatograph mass analysis meter) analyses were carried out for the substrates for storage media produced in the examples 5 to 7, for the qualitative-quantitative analyses of the components contained in the substrates for storage media.

[symbol]

Preprocess of the Specimens

[symbol]

The substrates for storage media were frozen and pulverized to carry out the Soxhlet extraction for about 4 hours at 75° C. with methanol. After the extraction, the extract was condensed with an evaporator.

[symbol]

Quantitative Analysis of the Glycerin

[symbol]

The quantitative analysis of the glycerin in the extract was carried out by appropriately diluting the methanol extract of each specimen with methanol, carrying out the GC measurement of the diluted solution under following measurement conditions, and using the calibration lines obtained from a known concentration glycerin reference solution. The results are shown in the table 2.

### * GC Measurement Conditions

Device: GC-2010 (produced by Shimadzu Corporation)
Column: DB-WAX (produced by J&W Scientific) 0.25 mm ID 30 m film thickness 0.25 μm
Oven temperature: 50° C.→240° C. temperature rise 8° C./min
Injection opening temperature: 250° C.
Detector temperature: 250° C.

### Pressure: 110 KPa

Injection method: Split method (split ratio 50:1) [symbol]
Detection of the Components Other than the Glycerin

[symbol]

The qualitative analysis of the detected components other than the glycerin was carried out by carrying out the GC/MS measurement by the following measurement conditions for the methanol extracts of each specimen. Moreover, from the detection peak area in the GC of each component, the content ratio in the specimen was roughly calculated based on the glycerin. The results are shown in the table 2.

### * GC/MS Measurement Conditions

Device: GC; HP5890A (produced by Agilent) MS; JMS-DX303 (produced by JEOL Ltd.)
Column: DB-WAX (produced by J&W Scientific) 0.25 mm ID 30 m film thickness 0.25 μm
Oven temperature: 50° C.-300° C. temperature rise 8° C./min
Injection opening temperature: 300° C.
Injection method: Split method (split ratio 30:1)

### Pressure: 15 psi

Ionizing method: EI (electron ionization)
Electron accelerating voltage: 70 eV
Measurement mass range: m/z 10 to 600
Scanning speed: 1.0 sec/scan

TABLE 2

| | Amount of added glycerin | Rate of content in the sample (% by mass) | | | |
|---|---|---|---|---|---|
| | (% by mass) | Glycerin | Methyl lactate | Methoxyethyl acetate | 1,4-butanediol |
| Example 5 | 16 | 9 | Not detected | Not detected | Not detected |
| Example 6 | 11 | 2 | 0.02 | 0.08 | 0.04 |
| Example 7 | 8 | 2 | 0.18 | 0.19 | 0.04 |

From the analysis results, to obtain an optical disk which has the adhesion strength to be peeled off easily with hands after the use, in the stage of the practical use, while ensuring sufficient adhesion strength in the production process of the optical disk, the components are considered to be desirable that the glycerin remains in the resin substrate to be used in an amount of 2% by mass or more, and in addition thereto, the methyl lactate is in an amount of 0.02% by mass or less, and the methoxyethyl acetate in an amount of 0.08% by mass or less, both having the effect of preventing the peel-off.

1-9. (canceled)

10. A substrate for storage media comprising: a resin substrate containing a starch resin; and a resin layer formed on the resin substrate,
wherein, after being left for a predetermined time, a compound having a carbonyl group is precipitated on a surface of the resin substrate.

11. The substrate for storage media according to claim 10, wherein the resin substrate contains: glycerin in an amount of 2% by mass or more; methyl lactate in an amount of 0.02% by mass or less; and methoxyethyl acetate in an amount of 0.08% by mass or less.

12. The substrate for storage media according to claim 10, wherein, in manufacturing of the resin substrate, the starch resin prepared by adding glycerin in an amount of 11% by mass or more is used.

13. (canceled)

14. A substrate for optical disk comprising:
a resin substrate containing a starch resin; and a resin layer, formed on the resin substrate, having a recording pit or a recording guide groove on the surface,
wherein, after being left for a predetermined time, a compound having a carbonyl group is precipitated on a surface of the resin substrate.

15. The substrate for optical disk according to claim 14, wherein the resin substrate contains: glycerin in an amount of 2% by mass or more; methyl lactate in an amount of 0.02% by mass or less; and methoxyethyl acetate in an amount of 0.08% by mass or less.

16. The substrate for optical disk according to claim 14, wherein, in manufacturing of the resin substrate, the starch resin prepared by adding glycerin in an amount of 11% by mass or more is used.

17. A method for manufacturing a recycled resin substrate, the method comprising a peeling step, in which the recycled resin substrate is formed, by peeling off a recording layer and a resin layer of storage media comprising a resin substrate containing a starch resin, the resin layer formed on the resin substrate, and the recording layer formed on the resin layer.
